(19) United States
(12) Patent Application Publication
(10) Pub. No.: US 2007/0036215 A1
(43) Pub. Date: Feb. 15, 2007

(54) Fast mode decision algorithm for intra prediction for advanced video coding

(76) Inventors: Feng Pan, Singapore (SG); Xiao Lin, Singapore (SG); Susanto Rahardja, Braddell View (SG); Keng Pang Lim, Singapore (SG); Zheng Guo Li, Singapore (SG); Ge Nan Feng, Singapore (SG); Da Jun Wu, Singapore (SG); Si Wu, Singapore (SG)

Correspondence Address: FULWIDER PATTON, 6060 CENTER DRIVE, 10TH FLOOR, LOS ANGELES, CA, 90045, US

(21) Appl. No.: 10/548,120

(22) PCT Filed: Mar. 3, 2004
(86) PCT No.: PCT/SG04/00047

§ 371 Date: Oct. 10, 2006

(30) Foreign Application Priority Data
Mar. 3, 2003 (US) 60451553

(51) Int. Cl. H04N 7/12; H04N 11/04

(52) U.S. Cl. 375/240.12; 375/240.24; 375/240.26

(57) ABSTRACT

A method (400) and an apparatus for AVC intra prediction to code digital video comprising a plurality of pictures are disclosed. The method comprises the steps of: generating (410) edge directional information for each intra block of a digital picture; and choosing (420) most probable intra prediction modes for rate distortion optimisation dependent upon the generated edge directional information. The edge directional information may be generated by applying at least one edge operator to the digital picture. The edge direction histogram may sum up the amplitudes of pixels with similar 15 directions in the block. The method may further comprise the step of intra coding (430) a block of the digital picture using the chosen most probable intra prediction modes.

### FIELD OF THE INVENTION

This invention relates generally to digital video processing and in particular to digital video coding and compression.

### BACKGROUND

To achieve the highest coding efficiency, advanced video coding (AVC) employs rate distortion optimisation (RDO) techniques to get the best coding result in terms of maximising coding quality and minimising resulting data bits. Advanced video coding includes AVC, H.264, MPEG-4 Part 10, and JVT. Further information about AVC can be found in ITU-T Rec. H.264|ISO/IEC 14496-10 AVC, “Joint Final Committee Draft (JFCD) of Joint Video Specification,” Klagenfurt, Austria, Jul. 22-26, 2002. To achieve RDO, the encoder uses all mode combinations to encode exhaustively the video. Such mode combinations include different intra and inter prediction modes. Consequently, the complexity and computational load of video coding in AVC increase drastically, which makes practical applications such as video communication difficult using state-of-the-art hardware systems.

Several efforts have been reported regarding fast algorithms in motion estimation for AVC video coding. See xiang Li and Guowei Wu, “Fast Integer Pixel Motion Estimation,” JVT-F011, 6th Meeting, Awaji Island, Japan, Dec. 5-13, 2002; Zhibo Chen, Peng Zhou, and Yun He, “Fast Integer Pel and Fractional Pel Motion Estimation for JVT,” JVT-F017, 6th Meeting, Awaji Island, Japan, Dec. 5-13, 2002; and Hye-Yeon Cheong Tourapis, Alexis Michael Tourapis and Pankaj Topiwala, “Fast Motion Estimation within the JVT Codec”, JVT-E023, 5th Meeting, Geneva, Switzerland, Oct. 9-17, 2002. However, no fast algorithm in intra prediction for AVC has been reported.

Intra coding refers to the case where only spatial redundancies within a video picture are exploited. The resulting picture is referred to as an I-picture. Traditionally, I-pictures are encoded by directly applying a transform to all macroblocks in the picture, which generates a much larger number of data bits compared to that of inter coding. To increase the efficiency of the intra coding, spatial correlation between adjacent macroblocks in a given picture is exploited in an AVC process. The macroblock of interest can be predicted from the surrounding macroblocks. The difference between the actual macroblock and its prediction is coded.

If a macroblock is encoded in intra mode, a prediction block is formed based on the previously encoded and reconstructed blocks. For the luminance (luma) components, intra prediction may be used for each 4×4 sub-block or 16×16 macroblock. There are nine prediction modes for 4×4 luma blocks and four prediction modes for 16×16 luma blocks. For the chrominance (chroma) components, four prediction modes may be applied to the two 8×8 chroma blocks (U and V). The resulting prediction mode for U and V components should be the same.

FIG. 1 illustrates the intra prediction for a 4×4 luma block 100, where pixels a top are the pixels to be predicted, and pixels A to I are the neighbouring pixels available at the time of prediction. If the prediction mode is chosen to be 0, the pixels a, e, i, and m are predicted based on the neighbouring pixel A; pixels b, f j and n are predicted based on pixel B, and so on. Besides the eight directional prediction modes 150 shown in FIG. 1, there is a ninth mode, i.e., a DC prediction mode, or Mode 2 in AVC.

Again, AVC video coding is based on the concept of rate distortion optimisation; the encoder has to encode the intra block using all the mode combinations and choose the one that gives the best RDO. According to the structure of intra prediction in AVC, the number of mode combinations for luma and chroma blocks in a macroblock is M8×(M4×16+M16), where M8, M4 and M16 represent the number of modes for 8×8 chroma blocks, 4×4 luma blocks, and 16×16 luma blocks, respectively. Thus, for a macroblock, 592 RDO calculations must be performed before a best RDO is determined. Consequently, the complexity and computational load of the encoder is extremely high.

### SUMMARY

In accordance with one aspect of the invention, there is provided a method of AVC intra prediction to code digital video comprising a plurality of pictures. The method comprises the steps of: generating edge directional information for each intra block of a digital picture; and choosing most probable intra prediction modes for rate distortion optimisation dependent upon the generated edge directional information.

The edge directional information may be generated by applying at least one edge operator to the digital picture. The edge operator may be applied to every luminance and chrominance pixel except any pixels of the borders of the luminance and chrominance components of the digital picture. The method may further comprise the step of deciding the amplitude and angle of an edge vector for a pixel. The edge directional information may comprise an edge direction histogram calculated for all pixels in each intra block. The edge direction histogram may be for a 4×4 luma block; prediction modes may comprise 8 directional prediction modes and a DC prediction mode. The edge direction histogram is for 16×16 luma and 8×8 blocks; prediction modes may comprise 2 directional prediction modes, a plane prediction mode, and a DC prediction mode.

The edge direction histogram may sum up the amplitudes of pixels with similar directions in the block.

The method may further comprise the step of terminating an RDO mode computation and rejecting the current RDO mode if the number of non-zero coefficients in a current RDO mode computation exceeds that in a previously computed RDO mode.

The method may further comprise the step of intra coding a block of the digital picture using the chosen most probable intra prediction modes.

In accordance with a further aspect of the invention, there is provided an apparatus using AVC intra prediction to code digital video comprising a plurality of pictures. The apparatus comprises a device for generating edge directional information for each intra block of a digital picture; and a device for choosing most probable intra prediction modes for rate distortion optimisation dependent upon the generated edge directional information. Other aspects of the apparatus may be implemented in line with aspects of the above method,

### BRIEF DESCRIPTION OF THE DRAWINGS

Embodiments of the invention are described hereinafter with reference to the drawings, in which:

FIG. 1 is an example of intra prediction for a 4×4 luma block;

FIG. 2 is an example of edge direction histogram for a 4×4 luma block;

FIG. 3 is an intra 8×8 and 16×16 prediction mode directions;

FIG. 4 is a high-level flow diagram illustrating a method of AVC intra prediction to code digital video comprising a plurality of pictures; and

FIG. 5 is a block diagram of a general purpose computer with which embodiments of the invention may be practised.

### DETAILED DESCRIPTION

A method, an apparatus, and a computer program product for AVG intra prediction to code digital video comprising a plurality of pictures are disclosed herein. While only a small number of embodiments are set forth, it will be appreciated by those skilled in the art that numerous changes and/or substitutions may be made without departing from the scope and spirit of the invention. In other instances, details well known to those skilled in the art may be omitted so as not to obscure the invention.

The embodiments of the invention provide a fast mode decision algorithm for AVC intra prediction based on local edge directional information, which reduces the amount of calculations in intra prediction. Based on edge information in the image block to be predicted, a local edge direction histogram, an edge directional field, or any other form of edge directional information is generated for each image block. Based on this edge directional information, a mechanism is provided to choose only a small number of the most probable intra prediction modes for rate distortion optimisation calculation. That is, with the use of edge direction histograms derived from the edge map of the picture, only a small number of most possible intra prediction modes are chosen for the RDO calculation. Therefore, the fast mode decision algorithm increases significantly the speed of intra coding. The pixels along a local edge direction are normally of similar values (both luma and chroma components). Therefore, a good prediction may be achieved if the pixels are predicted using those neighbouring pixels that are in the same direction as an edge.

Embodiments of the invention have one or more of the following features: Edge directional information in an image block (4×4, 8×8, 16×16, or any other block size) is used to guide the process of intra prediction;

Edge direction histogram may be used as the local edge directional information to guide the process of intra prediction;

Edge directional field may be used as the local edge directional information to guide the process of intra prediction.

Other forms of edge directional information in the image block may be used as the local edge directional information to guide the process of intra prediction;

One edge direction that has the strongest edge strength may be used as the best candidate for rate distortion optimisation calculation;

Two or more edge directions that have the stronger edge strength may be used as the preferred candidates for rate distortion optimisation calculation;

Early termination of the RDO mode calculation based on the number of non-zero coefficients after integer transform and zigzag scanning; and

Early termination of the RDO mode calculation based on the length of zero runs after an integer transform and zigzag scanning.

There are a number of ways to get the local edge directional information, such as edge direction histogram (see Rafael C. Gonzalez, Richard E. Woods, “Digital image processing,” Prentice Hall, 2002, p. 572), directional fields (see A. M. Bazen and S. H. Gerez, “Systematic methods for the computation of the directional fields and singular points of fingerprints,” IEEE Transactions on Pattern Analysis and Machine Intelligence, Vol. 24, pp. 905-919, July 2002), etc. The fast intra-mode prediction algorithm may be implemented based on both the edge direction histogram and directional fields, and the performance of the implementation has been compared in terms of time-saving, average PSNR and bit-rate for all the sequences recommended in JVT Test Model Ad Hoc Group, Evaluation sheet for motion estimation, Draft version 4, Feb. 19, 2003. The scheme based on edge direction histogram gives better performance. Therefore, the mode decision scheme described is based on edge direction histogram.

Edge Map

To obtain edge information in the neighbourhood of an intra block to be predicted, edge operators, such as Sobel edge operators, may be applied to an intra image to generate the edge map. Each pixel in the intra image is then associated with an element in the edge map, which is the edge vector containing its edge direction and amplitude. Prior to intra prediction, edge maps are created from the original picture.

The edge operator has two convolution kernels. Each pixel in the image is convolved with both kernels. One responds to the degree of difference in the vertical direction and the other in the horizontal. The edge operator is applied to every luminance and chrominance pixel except those pixels on the borders of luminance and chrominance pictures. This is because the operator cannot be applied to those pixels without 8 surrounding pixels. For a pixel p_{i,j}, in a luminance (or chrominance) picture, the corresponding edge vector, \vec{D}_{i,j}={dx_{i,j},dy_{i,j}}, is defined as follows:

$${dx}_{i , j} = {p}_{i - 1 , j + 1} + 2 ⨯ {p}_{i , j + 1} + {p}_{i + 1 , j + 1} - {p}_{i - 1 , j - 1} - 2 ⨯ {p}_{i , j - 1} - {p}_{i + 1 , j - 1} \\ {dy}_{i , j} = {p}_{i + 1 , j - 1} + 2 ⨯ {p}_{i + 1 , j} + {p}_{i + 1 , j + 1} - {p}_{i - 1 , j - 1} - 2 ⨯ {p}_{i - 1 , j} - {p}_{i - 1 , j + 1} \qquad ( 1 )$$

where dx_{i,j} and dy_{i,j} represent the degree of difference in the vertical and horizontal directions, respectively. Therefore, the amplitude of the edge vector can be decided by,
Amp(\vec{D}_{i,j})=|dx_{i,j}|+|dy_{i,j}| (2)

In fact the amplitude may be obtained more accurately using the rooted sum of the squares of dx_{i,j} and dy_{i,j}. However, in the circumstance of the fast algorithm, Equation (2) is usually used instead. The direction of the edge (in degree) is decided by the hyper-function:

$$Ang ( {\vec{D}}_{i , j} ) = \frac{{180}^{0}}{π} ⨯ arctan ( \frac{ⅆ {y}_{i , j}}{ⅆ {x}_{i , j}} ) , \vert Ang ( {\vec{D}}_{i , j} ) \vert < {90}^{0} \qquad ( 3 )$$

In one implementation of the algorithm, Equation (3) is not necessary, as in AVC there are only a limited number of directions that the prediction could be applied. In fact, simple thresholding techniques may be used to build up the edge direction histogram instead.

Edge Direction Histogram

To reduce the number of candidate prediction modes in RDO, an edge direction histogram is calculated from all the pixels in the block by summing up the amplitudes of hose pixels with similar directions in the block.

4×4 Luma Block Edge Direction Histogram

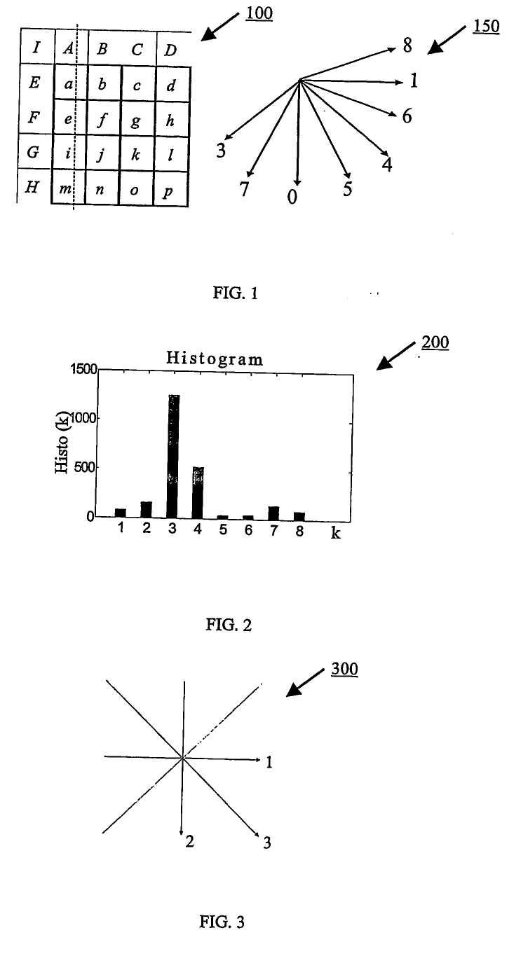

In the case of a 4×4 luma block, there are 8 directional prediction modes, as shown in FIG. 1, plus a DC prediction mode. The border between any two adjacent directional prediction modes is the bisectrix of the two corresponding directions. For example, the border of mode 1 (0) and mode 8 (26.6°) is the direction on 13.3°. It is important to note that mode 3 and mode 8 are adjacent due to circular symmetry of the prediction modes. The mode of each pixel is determined by its edge direction Ang(\vec{D}_{i,j}).

Therefore the edge direction histogram of a 4×4 luma block is decided as,

$$Histo ( k ) = {\sum }_{( m , n ) ∈ SET ( k )} Amp ( {\vec{D}}_{m , n} ) ,$$

SET(k)ε{{(i₀,j₀)},{i₁,i₁)},{(i₃,j₃)}, . . . ,{(iᵤ,jᵤ)} . . . ,{(i₈,j₈)}|Ang(\vec{D}ᵢ_{ᵢ}_{,j}_{ᵤ})εaᵤ},

while
a₀=(−103.3°,−76.7]
a₁=(−13.3°,13.3°]
a₃=(35.8°,54.2°]
a₄=(−35.8°,−54.2°]
a₅=(−54.2°,−76.7°]
a₆=(−35.8°,−13.3°]
a₇=(54.2°,76.7°]
a₈=(13.3°,35.8°] (4)

Note that k=1, . . . , 8 refers to 8 directional prediction modes. Note also that the angles of the direction in Equation (4) is 180° periodic. FIG. 2 shows an example of the edge direction histogram 200.

Edge Direction Histogram for 16×16 Luma and 8×8 Chroma Block

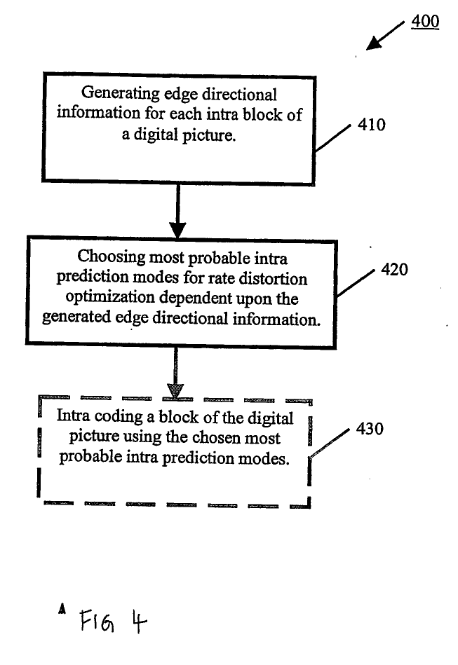

In the case of 16×16 luma and 8×8 chroma blocks, there are only two directional prediction modes, plus a plane prediction and a DC prediction mode. Therefore, the edge direction histogram for this case is based on three directions 300, i.e., horizontal, vertical and diagonal directions, as shown in FIG. 3.

Their edge direction histogram is constructed as follows,

$$Histo = {\sum }_{( m , n ) ∈ SET ( k )} Amp ( {\vec{D}}_{m , n} ) , \\ SET ( k ) ∈ \{ \{ {i}_{1} , {j}_{1} \} , … , \{ {i}_{u} , {j}_{u} \} … , \{ {i}_{3} , {j}_{3} \} \text{\vert} Ang ( {\vec{D}}_{{i}_{u} , {j}_{u}} ) ∈ {a}_{u} \} , \\ while \\ {a}_{1} = [ - {22.23}^{0} , {22.25}^{0} ] \\ {a}_{2} = ( - ∞ , - {67.5}^{0} ) ⋃ ( {67.5}^{0} , + ∞ , ) \\ {a}_{3} = Ω - ( {a}_{1} ⋃ {a}_{2} ) \qquad ( 5 )$$

where k=1 refers to the horizontal prediction mode, k=2 refers to vertical prediction mode, and k=3 refers to the plane prediction mode.

Histogram Based Fast Mode Selection for Intra Prediction

As mentioned above, each cell in the edge direction histogram sums up the amplitudes of those pixels with similar directions in the block. A cell with the maximum amplitude indicates that there is a strong edge presence in that direction, and thus could be used as the direction for the best prediction mode.

4×4 Luma Block Prediction Modes

Instead of performing the 9 mode RDO for 4×4 luma block, the fast algorithm only chooses some of the directional prediction modes with a higher possibility to be the candidate modes for intra 4×4 block prediction according to the edge direction histogram.

Since the pixels along an edge direction are likely to have similar values, the best prediction mode is probably in the edge direction whose cell has the maximum amplitude, or the directions close to the maximum amplitude cell. Therefore, the histogram cell with the maximum amplitude and the two adjacent cells are considered as candidates of the best prediction mode. In consideration of the case where all the cells have similar amplitudes in the edge direction histogram, the DC mode is also chosen as the fourth candidate.

Thus, for each 4×4 luma block, only 4 mode RDO calculation, may be performed instead of 9.

16×16 Luma Block Prediction Modes

Only the histogram cell with the maximum amplitude is considered as a candidate of the best prediction mode. Similarly as above, the DC mode is also chosen as the next candidate.

Thus, for each 1 6×1 6 luma block, only 2 mode RDO calculation may be performed, instead of 4.

8×8 Chroma Block Prediction Modes

In the case of chroma blocks, there are two different histograms, one from component U and the other from V. Therefore the histogram cells with maximum amplitude from the two components are both considered as candidate modes. As before, the DC mode also takes part in the RDO calculation. Note that if the direction with the maximum amplitude from the two components is the same, there could only 2 candidate modes for RDO calculation; otherwise, it is 3.

Thus, for each 8×8 chroma block, 2 or 3 mode RDO calculations are performed, instead of 4.

Table 1 summarises the number of candidates selected for the RDO calculation based on the edge direction histogram. As can be seen from Table 1, the encoder with the fast mode decision algorithm performs only 132˜198 RDO calculations, which is much less than that of current AVC video coding (592).

TABLE 1
Number of selected modes

| | Block size | Total No. of modes | No. of modes selected |
|---|---|---|---|
| Luma (Y) | 4 × 4 | 9 | 4 |
| Luma (Y) | 16 × 16 | 4 | 2 |
| Chroma (U, V) | 8 × 8 | 4 | 3 or 2* |

*The modes selected from the 2-chroma blocks may be the same.

Early Termination of Mode Computation

In the intra-prediction RDO mode computation, the most time-consuming portion lies in the context adaptive binary arithmetic coding (CABAC) coding. Also, the number of data bits generated after CABAC coding is heavily dependent on the number of non-zero coefficients after integer transform and zigzag scanning. Therefore, a simple early termination scheme in mode computation is implemented, i.e., if the number of non-zero coefficients in current RDO mode computation exceeds that in the previously computed RDO mode, an early termination of this RDO mode computation is activated and the current RDO mode is rejected.

AVC Intra Prediction

FIG. 4 is a high level flow diagram illustrating the method 400 of AVC intra prediction. In step 410, edge directional information for each intra block of a digital picture of the digital video is generated. In step 420, the most probable intra prediction modes are chosen for rate distortion optimisation dependent upon the generated edge directional information. In step 430, a block of the digital picture may be intra coded using the chosen most probable intra prediction modes. This method is well suited for implementation as hardware and/or software. In software, the computer program may be carried out using a microprocessor or computer. For example, the software may be executed on a personal computer as a software application, or may be embedded in a video recorder.

Computer Program Implementation

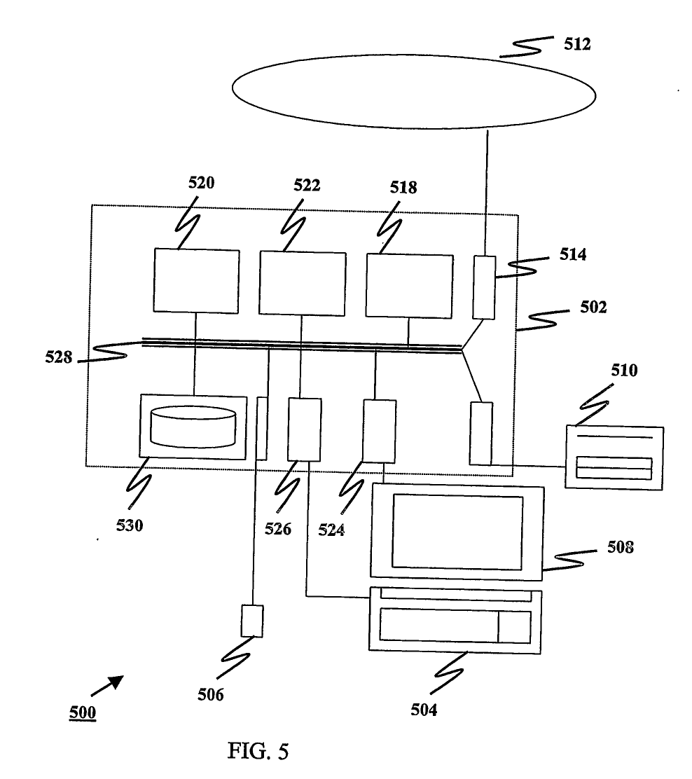

The method and apparatus of the above embodiment can be implemented on a computer system 500, schematically shown in FIG. 5. It may be implemented as software, such as a computer program being executed within the computer system 500, and instructing the computer system 500 to conduct the method of the example embodiment.

The computer system 500 comprises a computer module 502, input modules such as a keyboard 504 and mouse 506 and a plurality of output devices such as a display 508, and printer 510.

The computer module 502 is connected to a computer network 512 via a suitable transceiver device 514, to enable access to e.g. the Internet or other network systems such as Local Area Network (LAN) or Wide Area Network (WAN).

The computer module 502 in the example includes a processor 518, a Random Access Memory (RAM) 520 and a Read Only Memory (ROM) 522. The computer module 502 also includes a number of Input/Output (I/O) interfaces, for example V/O interface 524 to the display 508, and I/O interface 526 to the keyboard 804.

The components of the computer module 502 typically communicate via and interconnected bus 528 and in a manner known to the person skilled in the relevant art.

The application program is typically supplied to the user of the computer system 500 encoded on a data storage medium such as a CD-ROM or floppy disk and read utilising a corresponding data storage medium drive of a data storage device 530. The application program is read and controlled in its execution by the processor 518. Intermediate storage of program data may be accomplished using RAM 520.

In the foregoing manner, a method and an apparatus for AVC intra prediction to code digital video comprising a plurality of pictures have been disclosed. While only a small number of embodiments are set forth, it will be appreciated by those skilled in the art that numerous changes and/or substitutions may be made without departing from the scope and spirit of the invention.

1. A method of AVC intra prediction to code digital video comprising a plurality of pictures, said method comprising the steps of:
generating edge directional information for each intra block of a digital picture; and
choosing most probable intra prediction modes for rate distortion optimisation dependent upon said generated edge directional information.

2. The method according to claim 1, wherein said edge directional information is generated by applying at least one edge operator to said digital picture.

3. The method according to claim 2, wherein the at least one edge operator comprises at least one Sobel operator.

4. The method according to claim 2, wherein said edge operator is applied to every luminance and chrominance pixel except any pixels of the borders of the luminance and chrominance components of said digital picture.

5. The method according to claim 4, further comprising the step of deciding the amplitude and angle of an edge vector for a pixel.

6. The method according to claim 5, wherein the edge directional information comprises an edge direction histogram calculated for all pixels in each intra block.

7. The method according to claim 6, wherein said edge direction histogram is for a 4×4 luma block.

8. The method according to claim 7, wherein prediction modes comprise eight directional prediction modes and a DC prediction mode.

9. The method according to claim 6, wherein said edge direction histogram is for 16×16 luma and 8×8 blocks.

10. The method according to claim 9, wherein prediction modes comprise two directional prediction modes, a plane prediction mode, and a DC prediction mode.

11. The method according to claim 6, wherein said edge direction histogram sums up the amplitudes of pixels with similar directions in said block.

12. The method according to claim 1, wherein said edge directional information is generated by using directional field information generated from the digital picture.

13. The method according to claim 1, further comprising the step of terminating an RDO mode computation and rejecting the current RDO mode if the number of non-zero coefficients in a current RDO mode computation exceeds that in a previously computed RDO mode.

14. The method according to claim 1, further comprising the step of intra coding a block of said digital picture using said chosen most probable intra prediction modes.

15. An apparatus using AVC intra prediction to code digital video comprising a plurality of pictures, said apparatus comprising:
means for generating edge directional information for each intra block of a digital picture; and
means for choosing most probable intra prediction modes for rate distortion optimisation dependent upon said generated edge directional information.

16. The apparatus according to claim 15, wherein said edge directional information is generated by applying at least one edge operator to said digital picture.

17. The apparatus according to claim 16, wherein the at least one edge operator comprises at least one Sobel operator.

18. The apparatus according to claim 16, wherein said edge operator is applied to every luminance and chrominance pixel except any pixels of the borders of the luminance and chrominance components of said digital picture.

19. The apparatus according to claim 18, further comprising means for deciding the amplitude and angle of an edge vector for a pixel.

20. The apparatus according to claim 19, wherein the edge directional information comprises an edge direction histogram calculated for all pixels in each intra block.

21. The apparatus according to claim 20, wherein said edge direction histogram is for a 4×4 luma block.

22. The apparatus according to claim 21, wherein prediction modes comprise eight directional prediction modes and a DC prediction mode.

23. The apparatus according to claim 20, wherein said edge direction histogram is for 16×16 luma and 8×8 blocks.

24. The apparatus according to claim 23, wherein prediction modes comprise two directional prediction modes, a plane prediction mode, and a DC prediction mode.

25. The apparatus according to claim 20, wherein said edge direction histogram sums up the amplitudes of pixels with similar directions in said block.

26. The apparatus according to claim 15, wherein said edge directional information is generated by using directional field information generated from the said digital picture.

27. The apparatus according to claim 15, further comprising means for terminating an RDO mode computation and rejecting the current RDO mode if the number of non-zero coefficients in a current RDO mode computation exceeds that in a previously computed RDO mode.

28. The apparatus according to claim 15, further comprising means for intra coding a block of said digital picture using said chosen most probable intra prediction modes.

29. A computer program product having a computer program recorded on a computer readable medium using AVC intra prediction to code digital video comprising a plurality of pictures, said computer program product comprising:
computer program code means for generating edge directional information for each intra block of a digital picture; and
computer program code means for choosing most probable intra prediction modes for rate distortion optimisation dependent upon said generated edge directional information.

30. The computer program product according to claim 29, wherein said edge directional information is generated by applying at least one edge operator to said digital picture.

31. The computer program product according to claim 30, wherein the at least one edge operator comprises a Sobel operator.

32. The computer program product according to claim 30, wherein said edge operator is applied to every luminance and chrominance pixel except any pixels of the borders of the luminance and chrominance components of said digital picture.

33. The computer program product according to claim 32, further comprising computer program code means for deciding the amplitude and angle of an edge vector for a pixel.

34. The computer program product according to claim 33, wherein the edge directional information comprises an edge direction histogram calculated for all pixels in each intra block.

35. The computer program product according to claim 34, wherein said edge direction histogram is for a 4×4 luma block.

36. The computer program product according to claim 35, wherein prediction modes comprise eight directional prediction modes and a DC prediction mode.

37. The computer program product according to claim 34, wherein said edge direction histogram is for 16×16 luma and 8×8 blocks.

38. The computer program product according to claim 37, wherein prediction modes comprise two directional prediction modes, a plane prediction mode, and a DC prediction mode.

39. The computer program product according to claim 34, wherein said edge direction histogram sums up the amplitudes of pixels with similar directions in said block.

40. The computer program product according to claim 29, wherein said edge directional information is generated by applying at least one edge operator to said digital picture, or by using directional field information generated from the said digital picture.

41. The computer program product according to claim 29, further comprising computer program code means for terminating an RDO mode computation and rejecting the current RDO mode if the number of non-zero coefficients in a current RDO mode computation exceeds that in a previously computed RDO mode.

42. The computer program product according to claim 29, further comprising computer program code means for intra coding a block of said digital picture using said chosen most probable intra prediction modes.
